(19) United States
(12) Patent Application Publication
(10) Pub. No.: US 2007/0240835 A1
(43) Pub. Date: Oct. 18, 2007

(54) Blind slat

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/402,819

(22) Filed: Apr. 13, 2006

(51) Int. Cl. E06B 3/12

(52) U.S. Cl. 160/236

(57) ABSTRACT

A blind slat includes a thin and elongated slat body covering by a skin layer made from genuine leather, manmade leather or fabrics by stitching or bonding. The skin layer is printed with selected patterns and colors. Thus the blind slat has a versatile colored and patterned surface. The skin layer may be replaced and the patterns and colors may be changed. Practicality is enhanced.

### FIELD OF THE INVENTION

The present invention relates to a blind slat and particularly to a blind slat formed varying patterns and colors on the surface that are changeable.

### BACKGROUND OF THE INVENTION

The general blind slats made from plastics now on the market can be formed with varying colors during the extrusion process. However each slat usually is formed with one color. To change the color on the entire blind set, the common approach is to alter the color hue of the slats from light to dark. To form colorful patterns on the entire blind set is impossible. In other words, the conventional blind slat usually is formed with one color without colored patterns. The blind also tends to collect dust after in use for a period of time. It generally is cleaned through detergents and a great amount of water. Since the blind slats are rather soft and stacked up and down, cleaning task is tedious and time-consuming. In addition, as window shade is part of interior design, the fabric window shade has many choices that contain various desirable colors and patterns. It also may be stitched to from different decorative profiles. Aside from blocking sunshine, it also provides attractive indoor decorative effect. On the other hand, the blind made from plastics consists of a plurality of slats threaded in series. Each slat is fabricated individually. Hence it is not possible to print various colors and patterns on the entire blind slats. As a result, the blind usually looks plain and crude, and is not as appealing as the fabric window shade.

### SUMMARY OF THE INVENTION

In view of the aforesaid disadvantages occurred to the conventional blind slat, the primary object of the present invention is to provide a blind slat structure that includes a slat body made from wood or plastics and a skin layer to cover the slat body. The skin layer may be made from genuine leather, manmade leather or fabrics. The skin layer covers the slat body by stitching or bonding. The skin layer may be printed with patterns and colors. As a result, the blind slat also is colored and patterned. Moreover, the colors and patterns on the slat surface may be changed and replaced as desired. Therefore it is more versatile and practicality improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the invention.

FIG. 2 is a sectional view of an embodiment of the invention.

FIG. 3 is a sectional view of another embodiment of the invention.

FIG. 4 is a perspective view of the invention in a use condition.

### DETAILED DESCRIPTION OF THE PREFERRED EMBODIMENTS

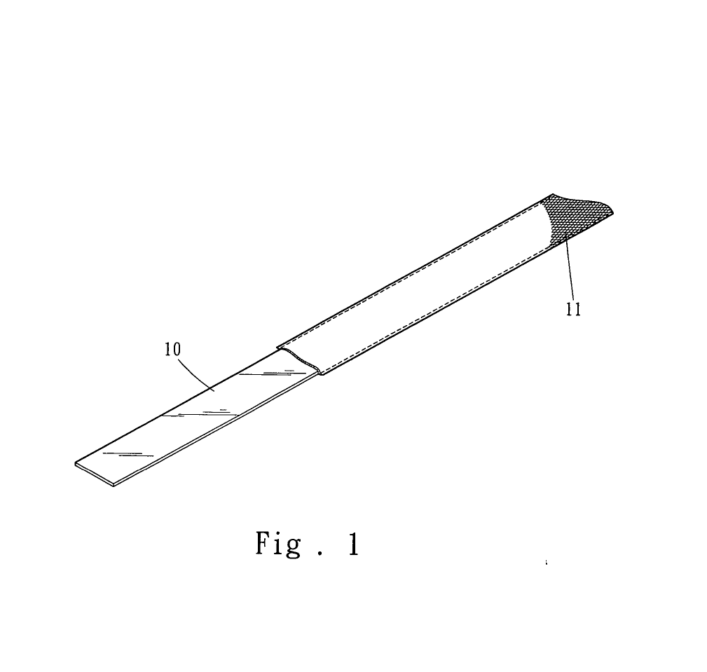

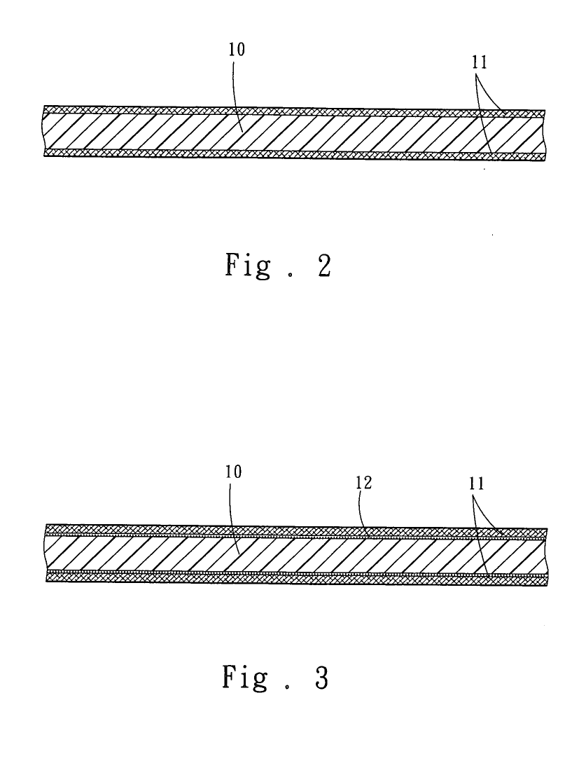

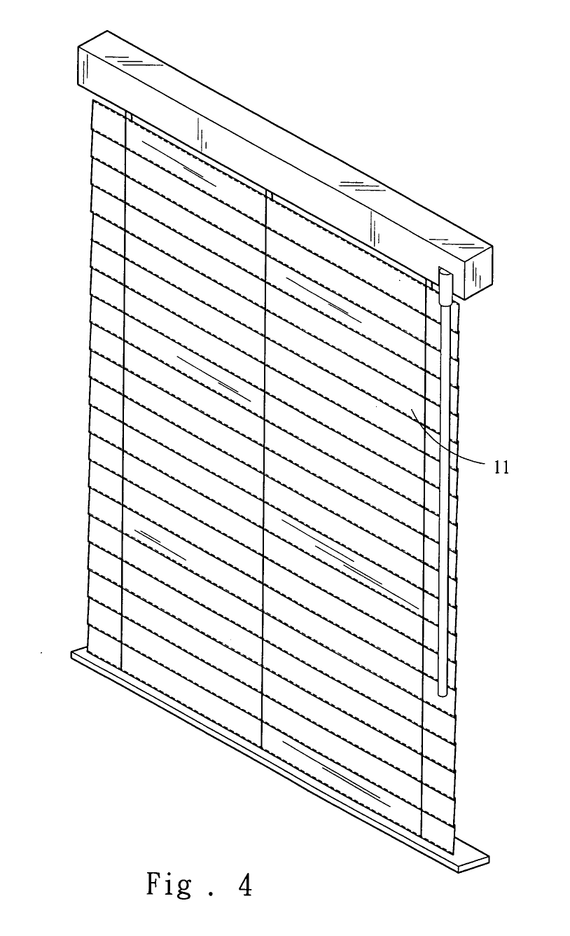

Please refer to FIGS. 1 and 2, the blind slat according to the invention includes a thin and elongated slat body 10 made from wood or plastics. The slat body 10 is covered by a skin layer 11 which may be made from manmade leather, genuine leather or fabrics. The skin layer 11 covers flatly the surface of the slat body 10 by stitching or bonding through a layer of adhesive 12 dispensing between the slat body 10 and the skin layer 11 as shown in FIG. 3.

Referring to FIG. 4, when in use, the surface of the skin layer 11 made from genuine leather, manmade leather or fabrics may be printed with desired patterns and colors. The entire blind set after assembly has continuous colored patterns on the slats. Thus it can be used to block sunshine and decorate rooms. After used for a period of time, the skin layer 11 may be removed from the slat body 10, and a new colored and patterned skin layer 11 may be provided to cover the slat body by stitching or bonding again. Such a structure frees the trouble of clearing the dust from the blind slats. The patterns on the surface of the blind slats can be changed and replaced whenever desired.

In short, the blind slat of the invention is covered by a skin layer 11 which may be printed in advance with varying colors and patterns. Covering of the skin layer 11 on the slat body 10 can be accomplished by stitching or bonding. Thereby the blind slats can provide varying colors and patterns to enhance visual effect. After used for a period of time, the skin layer 11 may be removed and the slat body may be covered by a new skin layer 11 of different colors and patterns. It provides more versatile decoration effect. The colors and patterns can be changed whenever desired. It offers a significant improvement over the conventional blind slats.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A blind slat comprising a thin and elongated slat body and a skin layer covering the slat body by stitching.

2. The blind slat of claim 1, wherein the skin layer covers the slat body by bonding.

3. The blind slat of claim 1, wherein the slat body is selectively made from one of wood and plastics.

4. The blind slat of claim 1, wherein the skin layer is selectively made from one of genuine leather, manmade leather and fabrics.

5. The blind slat of claim 1, wherein the skin layer is printed with selected patterns and colors.
